(19) United States
(12) Patent Application Publication
(10) Pub. No.: US 2020/0260707 A1
(43) Pub. Date: Aug. 20, 2020

(54) MOTORIZED FISHING REEL ASSEMBLY

(71) Applicant: One-Der-Reel, LLC, Lakeville, PA (US)

(72) Inventors: Kym A. Mullen, Narrowsburg, NY (US); Robert S. Walsh, SR., Lakeville, PA (US)

(21) Appl. No.: 16/278,850

(22) Filed: Feb. 19, 2019

(51) Int. Cl. A01K 89/017; A01K 89/015

(52) U.S. Cl. CPC A01K 89/017; A01K 89/01928

(57) ABSTRACT

A handle assembly for a fishing rod and reel assembly. The handle assembly includes a handle body extending from a first end to a second end along a first central axis. The handle body defines a gripping area and a reel seat. A motor actuation button is defined along the handle body. A motor mount is connected to the handle body and extends along a second central axis from a generally closed end to a second end defining an opening. A motor is positioned in the motor mount such that a rotating connector extends from the opening in the motor mount. A rotating drive mechanism is connected at a first end to the rotating connector and has a second end configured for connection to a spool shaft of a reel which is configured for connection to the handle body reel seat. A power source is electrically connected with the motor actuation button and the motor. Pressing of the motor actuation button causes the motor to rotate which in turn causes the second end of the rotating drive mechanism to rotate in a reeling in direction.

### FIELD OF THE INVENTION

This invention relates to fishing gear, in particular, to a rod and reel assembly. More specifically, the invention relates to a rod and motorized reel assembly.

### BACKGROUND OF THE INVENTION

A typically rod and reel assembly includes a rod extending from a handle and a reel connected to the handle. While reels come in various forms, they generally include a length of fishing line wound on a spool. After the fishing line has been cast, it is necessary to real in the fishing line by rotating a spool shaft engaged with the spool. Typically such requires a user to hold the handle in one hand and rotate the spool shaft, for example, via a reel crank, with the other hand. Such dual handed action may be difficult for some users.

Additionally, the casting procedure generally requires a fluid motion of flipping the handle to cast the line from the reel. The procedure may require further action during the flipping motion, for example, pressing of a release button as required with a spincast reel.

There is a need for a rod and reel assembly with an ergonomic handle assembly which allows for one handed casting and reeling.

### SUMMARY OF THE INVENTION

In at least one embodiment, the present invention provides a handle assembly for a fishing rod and reel assembly. The handle assembly includes a handle body extending from a first end to a second end along a first central axis. The handle body defines a gripping area and a reel seat. A motor actuation button is defined along the handle body. A motor mount is connected to the handle body and extends along a second central axis from a generally closed end to a second end defining an opening. A motor is positioned in the motor mount such that a rotating connector extends from the opening in the motor mount. A rotating drive mechanism is connected at a first end to the rotating connector and has a second end configured for connection to a spool shaft of a reel which is configured for connection to the handle body reel seat. A power source is electrically connected with the motor actuation button and the motor. Pressing of the motor actuation button causes the motor to rotate which in turn causes the second end of the rotating drive mechanism to rotate in a reeling in direction.

In at least one embodiment, the present invention provides a fishing rod and reel assembly. The assembly includes a reel, a handle assembly and a rod. The reel has a housing which rotatably supports a spool which is rotatable via a spool shaft. The handle assembly includes a handle body extending from a first end to a second end along a first central axis. The handle body defines a gripping area and a reel seat and the reel is connected to the handle body at the reel seat. A motor actuation button is defined along the handle body. A motor mount is connected to the handle body and extends along a second central axis from a generally closed end to a second end defining an opening. A motor is positioned in the motor mount such that a rotating connector extends from the opening in the motor mount. A rotating drive mechanism is connected at a first end to the rotating connector and has a second end connected to the spool shaft of the reel. A power source is electrically connected with the motor actuation button and the motor. Pressing of the motor actuation button causes the motor to rotate which in turn causes the second end of the rotating drive mechanism to rotate which rotates the spool shaft in a reeling in direction.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a rod and reel assembly in accordance with an embodiment of the invention.

FIG. 2 is an expanded perspective view of the rod and reel assembly of FIG. 1.

FIG. 3 is an exploded perspective view of the rod and reel assembly of FIG. 1.

FIG. 4 is a side elevation view of the rod and reel assembly of FIG. 1.

FIG. 5 is a cross-sectional view along the line 5-5 of FIG. 4, with the cross-section portion of the reel shown in phantom.

FIG. 6 is a cross-sectional view along the line 6-6 of FIG. 5, with the cross-section portion of the reel shown in phantom.

### DETAILED DESCRIPTION OF THE INVENTION

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiments described herein.

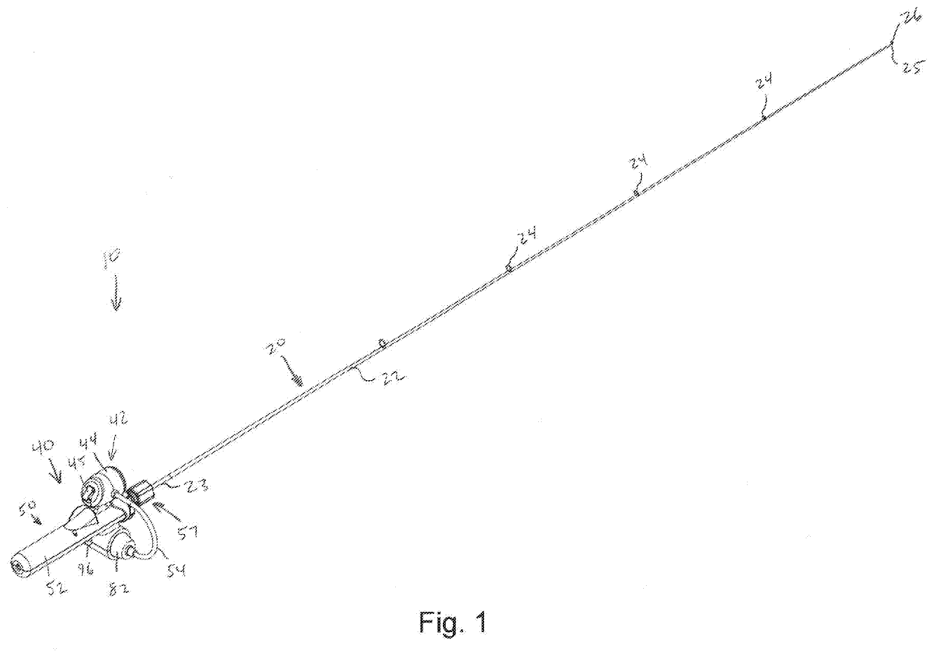

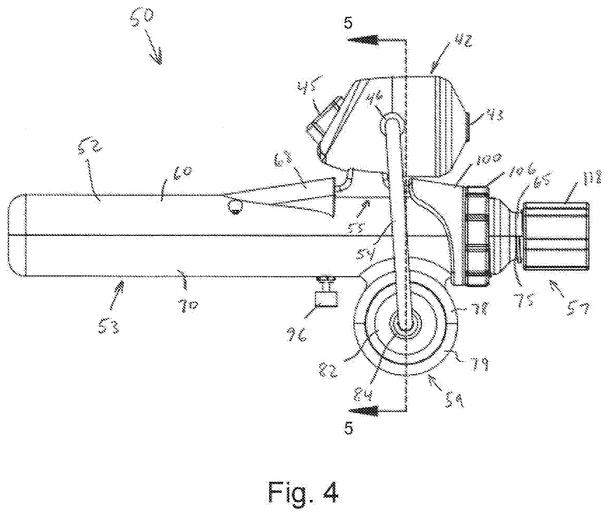

Referring to FIGS. 1-6, an exemplary embodiment of a rod and reel assembly 10 in accordance with an embodiment of the invention will be described. The rod and reel assembly 10 generally comprises a rod 20 and a motorized reel assembly 40. The rod 20 includes a rod blank 22 extending from a rear end 23 to a tip 25. A plurality of guide loops 24 are defined along rod blank 22 and a tip loop 26 is defined at the tip 25 thereof. The rod 20 may have any desired configuration, for example, the length, diameter and flexibility of the rod blank 22, the number of guide loops 24 and the configuration of the tip loop 26. As will be described hereinafter, the motorized reel assembly 40 includes a connection assembly 57 which allows a user to easily connect any desired rod 20 thereto.

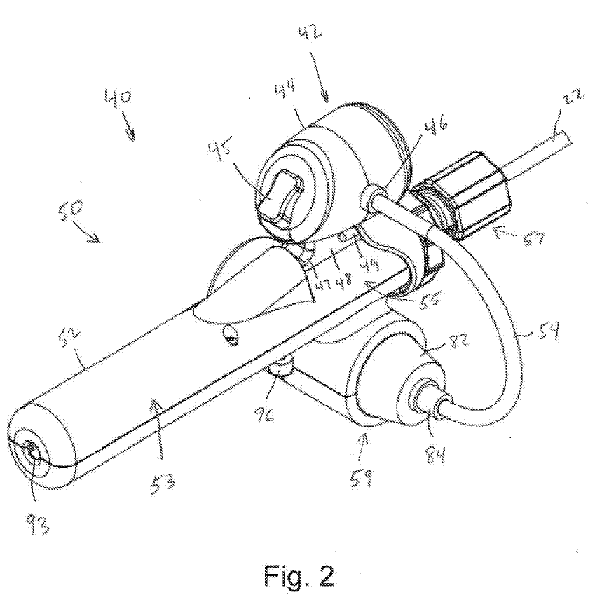

Referring to FIGS. 1 and 2, the motorized reel assembly 40 comprises a reel 42 and a handle assembly 50. The illustrated reel 42 is a spincast type reel, however, the invention is not limited to such and any desired reel having a driveable spool shaft may be utilized, for example, baitcasting, casting or spinning reels. The illustrated reel 42 includes a housing 44 which encloses the spool and spool shaft (not shown). A forward end of the housing 44 defines a hole 43 for the fishing line (not shown) to pass through and wind about the spool. The opposite end of the housing 44 supports a line release button 45. Depressing of the release button 45 unlocks the spool shaft, allowing the spool to spin free such that the line may be cast. A slight reeling of the spool shaft, which can be accomplished with the motor actuation button 96 as described below, reengages the spool shaft such that the line may be reeled in via the motor 82. The spool shaft is aligned with a shaft connection opening 46 in the housing 44. The reel 42 also includes a reel foot 48 with a rear projection 47 and a forward projection 49 which are configured to be retained in the reel seat 55 of the handle assembly 50, as described in detail below.

The handle assembly 50 includes a body 52 which defines a grip area 53, the reel seat 55, the connection assembly 57 and a motor mount 59. The handle assembly 50 also includes a flexible drive member 54 extending from a motor 82 to the spool shaft through the shaft connection opening 46. The motor actuation button 96 extends from the grip portion 53 of the body 52 and is easily accessible to a user. Pressing of the actuation button 96 causes the motor 82 to rotate which drives the flexible drive 54 and causes the spool shaft (not shown) to rotate in a reeling in direction. To reengage the spool shaft after casting, the user presses the actuation button 96 for a short period. Thereafter, the user can reel in the line a desired amount by pressing and holding in the actuation button 96.

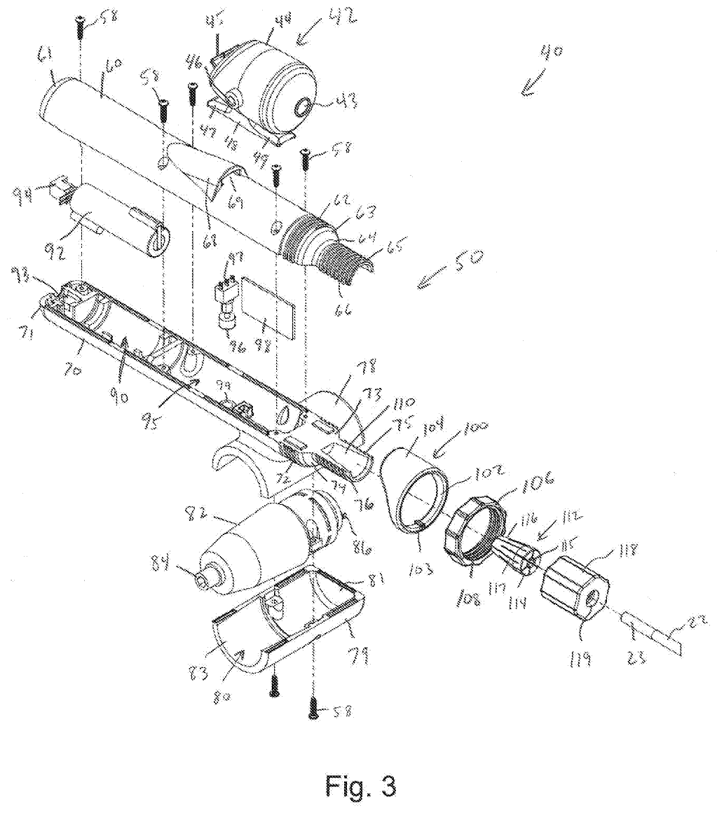

With reference to FIGS. 3 and 6, the illustrated handle assembly 50 will be described in more detail. In the illustrated embodiment, the handle body 52 is defined by opposed handle portions 60, 70. The first handle portion 60 has a semi-cylindrical configuration extending from a rear end 61 to a forward end 63. A series of threads 62 are defined near the forward end 63. Forward the threads 62, the handle portion 60 tapers as illustrated at 64 to a connection area 65 with a series of threads 66 defined therealong. A raised portion 68 extends from the first handle portion 60 and defines a slot 69 configured to receive the rear projection 47 of the reel foot 48.

The second handle portion 70 has a semi-cylindrical configuration extending from a rear end 71 to a forward end 73. A series of threads 72 are defined near the forward end 73 and align with the threads 62 to define circumferential threads. Forward the threads 72, the handle portion 70 tapers as illustrated at 74 to a connection area 75 with a series of threads 76 defined therealong. The threads 76 align with the threads 66 to define circumferential threads. The first and second portions 60, 70 are interconnected with screws 58 or the like to define the cylindrical body 52. While the body 52 is illustrated with a cylindrical configuration, the invention is not limited to such and the body may have other configurations.

Within the body 52, the first and second portions 60, 70 define first and second chambers 90 and 95. The body portions 60, 70 are preferably interconnected in a sealed manner such that the chambers 90, 95 are generally water tight. The first chamber 90 is configured to receive and house a rechargeable battery 92. The battery 92 has a charging port 94 connected thereto. The charging port 94 aligns with a charging hole 93 defined through the rear ends 61, 71 of the body portions 60, 70. While a rechargeable battery is illustrated, other batteries, including batteries that cannot be recharged, may be utilized. In such case, the handle body 52 would include a removable cap or the like. As another alternative, the handle assembly 50 may be configured for connection to an external power source. The chamber 95 is configured to receive the internal portion of the actuation button 96 through a hole 99 in the body portion 70. The actuation button 96 includes one or more internal contacts 97. In the illustrated embodiment, the chamber 95 also supports a control circuit board 97 which is connected with the battery 92, the actuation button 96 and the motor 82. The control circuit board 97 may be programmed to control operation of the motor 82 in response to pressing of the actuation button 96. Alternatively, the actuation button 96 may be directly electrically connected to the motor 82 with the motor 82 having control circuitry built therein.

The motor mount 59 depends from the body portion 70 and has a central axis extending generally perpendicular to the central axis of the handle body 52. The motor mount 59 includes first and second mount portions 78, 79. The mount portions 79 are interconnected to define a chamber 80 extending between a closed end 81 and an open end 83. The motor 82 is positioned within the chamber 80 such that a rotating connector 84 extends from the open end 83 and one or more contacts 86 are positioned within the chamber 80. The contacts 86 are electrically connected with the actuation button 96, through the control circuit board 98 in the illustrated embodiment. The motor 82 is preferably sealingly positioned within the open end 83.

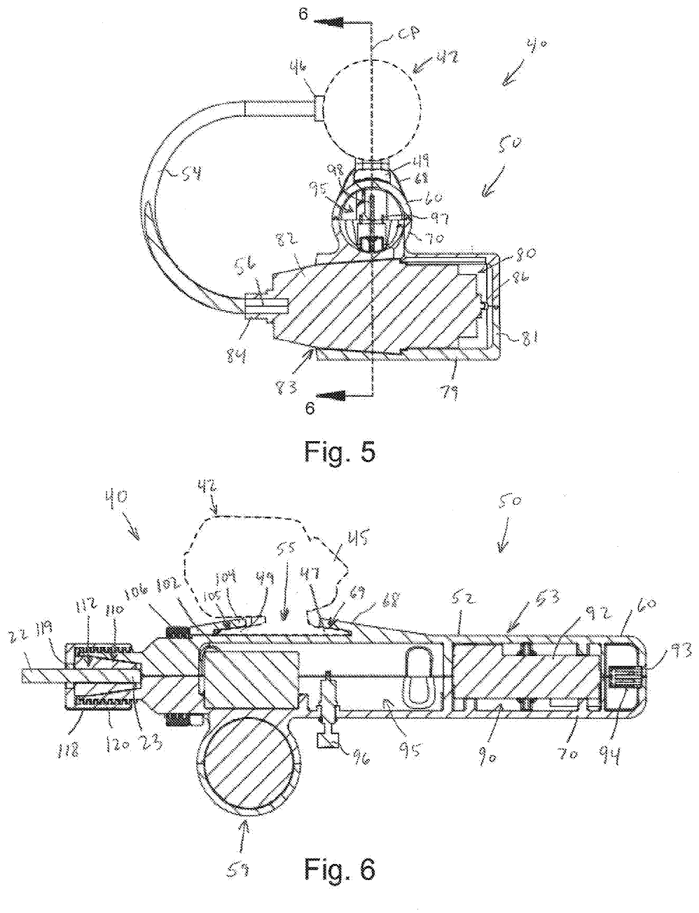

As shown in FIG. 5, a connecting member 56 of the flexible drive 54 engages the rotating connector 84 such that rotation of the motor 82 causes rotation of the flexible drive 54, and thereby the spool shaft. The motor mount 59 is preferably orientated such that the rotating connector 84 and the shaft connection opening 46 of the reel 42 are on the same side of a central plane CP extending through the handle assembly 50. With such a configuration, the flexible drive 54 easily extends between the rotating connector 84 and the shaft connection opening 46 without interfering with other elements of the assembly. While a flexible connector is illustrated, it is understood that other mechanisms for transmitting rotation force from the rotating connector 84 to the spool shaft may be utilized. For example, a series of shafts and beveled gears may be utilized.

Referring to FIGS. 3, 4 and 6, the reel seat 55 of the illustrated embodiment of the invention will be described. The raised portion 68 and the slot 69 defined thereby define a rear end of the reel seat 55. The forward end of the reel seat 55 is defined by a removable saddle 100 positionable over the forward ends 63, 73 of the handle body portions 60, 70. The saddle 100 includes a ring portion 102 configured to extend about the handle body 52. The ring portion 102 may have a keying member 103 defined on an inside surface and configured to engage in a groove (not shown) in the handle body 52 to ensure proper alignment of the saddle 100. A projecting portion 104 extends from the ring portion 102. When the saddle 100 is positioned on the handle body 52, a slot 105 is defined between the projecting portion 104 and the surface of the body portion 60. As shown in FIG. 6, the front projection 49 of the reel foot 48 is configured to be received in the slot 105. A locking nut 106, defining internal threads 108, is threadably engaged with the threads 62, 72 to lock the saddle 100 in position and thereby lock the reel 42 in position relative to the handle assembly 50. Such an assembly allows for easy connection and disconnection of the reel 42 from the handle assembly 50, even utilizing one hand.

Referring to FIG. 6, it is seen that the reel seat 55 is positioned along the body portion 60 in approximate axial alignment with the motor mount 59 depending from the body portion 70. With this configuration, the weight of the reel 42 and the weight of the motor 82 generally aligned and both act to the forward end of the handle assembly 50. As such, the assembly 40 is ergonomic, with the weight of the reel 42 and the motor 82 both acting in concert with the natural casting motion. It is further seen that the line release button 45 and the actuation button 96 are also in approximate axial alignment on opposite sides of the handle body 52. With this configuration, both buttons 45, 96 are easily accessible to a user while they are gripping the gripping portion 53. For example, the line release button 45 may be accessed by the users thumb while the user's forefinger is aligned with and ready to actuate the actuation button 96. While the illustrated embodiment provides a preferred functionality, it is recognized that the components may be otherwise arranged. Additionally, while the illustrated embodiment achieves a desired functionality, it is understood that a handle assembly having a different aesthetic appearance may achieve similar functionality.

Referring to FIGS. 3 and 6, the illustrated connection assembly 57 will be described. The opposed connection areas 65, 75 define a tapered internal chamber 110. The chamber 110 is configured to receive a locking member 112. The locking member 112 has a forward end 114 and a tapered rear end 116. An opening 115 extends into the locking member 112 and is configured to receive the rear end 23 of the rod blank 22. The locking member 112 includes a plurality of axial slits 117 which allow the locking member to expand as the rod blank 22 is received. The locking member 112, with the rear end 23 of the rod blank 22 is positioned partially into the chamber 110. A lock nut 118 with a hole 119 for passage of the rod blank 22 and internal threads 120 is threadably secured onto the threads 66, 76. As the lock nut 118 is tightened, the locking member 112 is forced into the tapered chamber 110. The taper of the chamber 110 acts to compress the locking member 112, thereby locking the rod blank 22 to the handle assembly 50. Such an assembly allows for easy connection and disconnection of the rod 20 from the handle assembly 50, even utilizing one hand. Additionally, the connection assembly 57 allows for easy interchanging of types of rod blanks 22. For example, a user could use a 24 inch jigging pole rod blank for ice fishing, and then, if desired, interchange it with any one or two piece rod blank up to a 9 foot long crappie rod. Any desired rod blank may be connected to form a desired rod application while still utilizing the same motorized drive handle.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

What is claimed is:

1. A handle assembly for a fishing rod and reel assembly, the handle assembly comprising:
a handle body extending from a first end to a second end along a first central axis, the handle body defining a gripping area and a reel seat;
a motor actuation button defined along the handle body;
a motor mount connected to the handle body, the motor mount extending along a second central axis from a generally closed end to a second end defining an opening;
a motor positioned in the motor mount such that a rotating connector extends from the opening in the motor mount;
a rotating drive mechanism connected at a first end to the rotating connector and having a second end configured for connection to a spool shaft of a reel which is configured for connection to the handle body reel seat; and
a power source electrically connected with the motor actuation button and the motor;
wherein pressing of the motor actuation button causes the motor to rotate which in turn causes the second end of the rotating drive mechanism to rotate in a reeling in direction.

2. The handle assembly according to claim 1 wherein the second central axis is substantially perpendicular to the first central axis.

3. The handle assembly according to claim 1 wherein the motor mount is positioned on a surface of the handle body which is opposite of the reel seat.

4. The handle assembly according to claim 1 wherein the motor mount and the reel seat are both forward of the gripping area.

5. The handle assembly according to claim 4 wherein the motor mount and the reel seat are generally axially aligned.

6. The handle assembly according to claim 1 wherein the motor actuation button is positioned on a surface of the handle body which is opposite of the reel seat.

7. The handle assembly according to claim 6 wherein the motor actuation button is axially positioned toward the rear end of the reel seat.

8. The handle assembly according to claim 1 wherein the power source is one or more batteries positioned within the handle body.

9. The handle assembly according to claim 8 wherein the handle body is sealed to be water resistant.

10. The handle assembly according to claim 1 wherein the motor mount is sealed to be water resistant.

11. The handle assembly according to claim 1 wherein the first end of the handle body defines a connection assembly configured for connection of a rod blank to the handle assembly.

12. The handle assembly according to claim 1 wherein the drive mechanism is a flexible drive.

13. A fishing rod and reel assembly comprising:
a reel a housing which rotatably supports a spool which is rotatable via a spool shaft;
a handle assembly comprising:
a handle body extending from a first end to a second end along a first central axis, the handle body defining a gripping area and a reel seat, wherein the reel is connected to the handle body at the reel seat;
a motor actuation button defined along the handle body;
a motor mount connected to the handle body, the motor mount extending along a second central axis from a generally closed end to a second end defining an opening;
a motor positioned in the motor mount such that a rotating connector extends from the opening in the motor mount;
a rotating drive mechanism connected at a first end to the rotating connector and having a second end connected to the spool shaft of the reel; and
a power source electrically connected with the motor actuation button and the motor; and
a rod connected to the second end of the handle body;
wherein pressing of the motor actuation button causes the motor to rotate which in turn causes the second end of the rotating drive mechanism to rotate which rotates the spool shaft in a reeling in direction.

13. The fishing rod and reel assembly according to claim 12 wherein the second central axis is substantially perpendicular to the first central axis.

14. The fishing rod and reel assembly according to claim 12 wherein the motor mount is positioned on a surface of the handle body which is opposite of the reel seat.

15. The fishing rod and reel assembly according to claim 14 wherein the motor mount and the reel seat are generally axially aligned.

16. The fishing rod and reel assembly according to claim 12 wherein the motor actuation button is positioned on a surface of the handle body which is opposite of the reel seat.

17. The fishing rod and reel assembly according to claim 16 wherein the reel includes a line release button and the motor actuation button is generally axially aligned with the line release button.

18. The fishing rod and reel assembly according to claim 12 wherein the power source is one or more batteries positioned within the handle body.

19. The fishing rod and reel assembly according to claim 12 wherein the drive mechanism is a flexible drive.

20. The fishing rod and reel assembly according to claim 12 wherein the rotating drive mechanism and an area of the reel at which the rotating drive mechanism is connected to the spool shaft of the reel are on the same side of the handle assembly.
